(19) United States
(12) Patent Application Publication
(10) Pub. No.: US 2026/0264796 A1
(43) Pub. Date: Sep. 10, 2026

(54) Telescopic Electric Suitcase

(71) Applicant: Zhejiang Xier Technology Co., Ltd, Hangzhou City (CN)

(72) Inventors: Guansheng Luo, Fuyang City (CN); Kai Yang, Tuanfeng County (CN); Yi Wu, Hangzhou City (CN); Meng Sun, Fuxin City (CN)

(21) Appl. No.: 19/203,205

(22) Filed: May 9, 2025

(30) Foreign Application Priority Data
Mar. 6, 2025 (CN) 202520386643.8

(51) Int. Cl. B62K 15/00; B62J 50/22; B62K 19/46; B62K 21/12; B62K 23/02; B62L 3/00; B62M 7/12

(52) U.S. Cl. CPC B62K 15/00; B62J 50/22; B62K 19/46; B62K 21/12; B62K 23/02; B62L 3/00; B62M 7/12; B62K 2202/00

(57) ABSTRACT

Disclosed is a telescopic electric suitcase, including a suitcase body assembly, a handle assembly, a base assembly, and a front wheel assembly and a rear wheel assembly. The base assembly includes a telescopic outer rod assembly and a telescopic inner rod assembly. A housing is further included, and a locking mechanism is arranged inside the telescopic inner rod assembly and configured for locking the base assembly, which prevents extension or retraction caused by road vibrations during travel and enhances product stability. A pulling mechanism is arranged inside the housing, and the user drives the locking mechanism to move for unlocking by manually toggling the pulling mechanism.

### CROSS REFERENCE TO RELATED APPLICATIONS

The present disclosure claims the priority of Chinese Patent Application No. 202520386643.8 filed on 03/06/2025. All the above are hereby incorporated by reference in their entirety.

### TECHNICAL FIELD

The present disclosure relates to the technical field of suitcases, and in particular to a telescopic electric suitcase.

### BACKGROUND

A suitcase, also known as a travel case or a wheeled suitcase is a container used for carrying personal items during travel, and is one type of luggage case. Generally, the suitcase is used to store clothing, personal care supplies, and souvenirs needed during travel, which facilitates transport. Wheels are arranged at bottoms of most suitcases to facilitate movement. To enhance user convenience, electric suitcases provided with frames are available on the market. The user sitting on an electric suitcase mounted on a frame moves during travel, while is driven by a motor, making it easier to carry luggage.

Telescopic electric suitcases are available on the market. A locking structure is required to prevent unintended telescopic movement of an electric suitcase during driving. The locking mechanism is configured to lock the electric suitcase in an extended or retracted state. However, telescopic locking mechanisms of electric suitcases of the prior art are relatively ordinary, making it cumbersome and inconvenient for users to operate.

### SUMMARY

In order to overcome the defects in the prior art, the present disclosure provides a telescopic electric suitcase. In order to solve the above technical problems, the present disclosure adopts the following technical solution.

A telescopic electric suitcase, includes a suitcase body assembly, a handle assembly, a telescopic base assembly, and a front wheel assembly and a rear wheel assembly arranged at a bottom thereof, where a steering assembly is arranged between the front wheel assembly and the handle assembly. The base assembly includes a telescopic outer rod assembly and a telescopic inner rod assembly, where one end of the telescopic inner rod assembly is movably connected to inside of the telescopic outer rod assembly, and the other end thereof is connected to the steering assembly. A locking mechanism is arranged on the base assembly, and the locking mechanism is configured to lock the telescopic inner rod assembly and the telescopic outer rod assembly. A pulling mechanism in linked connection with the locking mechanism is further included, and the pulling mechanism unlocks the locking mechanism.

Further, the locking mechanism includes a base fixed inside the telescopic inner rod assembly, and a drive rod and a locking block movably mounted inside the base, where the drive rod is linked to the locking block, the drive rod is linked to the pulling mechanism, and the drive rod drives the locking block to move to achieve unlocking.

Further, an inserting pin for locking the telescopic inner rod assembly and the telescopic outer rod assembly is arranged on a side of the locking block.

Further, the base is provided with a first slot and a second slot that are communicated with each other, the drive rod is horizontally movably mounted in the first slot, the locking block is vertically movably mounted in the second slot, and a reset spring is arranged between the second slot and the locking block; and a first inclined block is arranged at a bottom of the drive rod, a second inclined block fitted with the first inclined block is arranged at a top of the locking block, and when the drive rod moves, the first inclined block drives the second inclined block to move.

Further, the pulling mechanism includes a handle and a linkage member that moves with the handle, and the linkage member is connected to the drive rod.

Further, the linkage member includes a rotating block, a pulling wire, and a columnar body that protrudes from an inner side of the handle, where the pulling wire is connected to one end of the rotating block, the columnar body is in contact with the other end of the rotating block, and the handle drives the rotating block to rotate through the columnar body, which simultaneously drives the pulling wire to move to release a locking state of the locking mechanism.

Further, the telescopic outer rod assembly includes a telescopic outer rod and an outer rod sleeve mounted inside the telescopic outer rod, and the telescopic inner rod assembly includes a telescopic inner rod and an inner rod sleeve mounted on an outer surface of the telescopic inner rod.

Further, the front wheel assembly includes a fork and a hub motor mounted below the fork, and the steering assembly includes an adapter and bearings arranged at upper and lower ends of the adapter, where the fork penetrates through the adapter and the two bearings and is connected to the handle assembly, and the telescopic inner rod assembly is connected to the adapter.

Further, the handle assembly includes a handle rod, a vertical rod, a connector, and an adjustable locator, where the vertical rod is connected to an upper end of the fork and reinforced through the connector, and the handle rod is telescopically mounted on the vertical rod and fixed through the locator.

Further, a housing that wraps around the handle assembly and the steering assembly is further included, a control panel is arranged inside the housing, and the handle assembly is provided with a brake button, a drive ring, and a display screen that are electrically connected to the control panel, where a master power switch is arranged on the display screen.

A telescopic electric suitcase, includes a suitcase body assembly, a handle assembly, a telescopic base assembly, and a front wheel assembly and a rear wheel assembly arranged at a bottom thereof, where a steering assembly is arranged between the front wheel assembly and the handle assembly. The base assembly includes a telescopic outer rod assembly and a telescopic inner rod assembly, where one end of the telescopic inner rod assembly is movably connected to inside of the telescopic outer rod assembly, and the other end thereof is connected to the steering assembly.

A locking mechanism and a pulling mechanism are further included, the locking mechanism includes a base, a drive rod movably mounted inside the base, and a locking block linked to the drive rod, where the drive rod is linked to the pulling mechanism, and the drive rod drives the locking block to move to achieve unlocking; and

an inserting pin for locking the base assembly is arranged on a side of the locking block, the pulling mechanism moves to unlock the base assembly through the inserting pin, and the telescopic inner rod assembly and the telescopic outer rod assembly are movably adjusted.

Further, the inserting pin penetrates through the telescopic inner rod assembly, a plurality of pin holes are formed on the telescopic outer rod assembly, and the inserting pin is inserted into the pin hole at a different position to achieve fixing after extension or retraction.

Compared with the prior art, the present disclosure has the beneficial effects as follows:

The base assembly of the present disclosure includes the telescopic outer rod assembly and the telescopic inner rod assembly, and the user extends or retracts the base assembly according to use needs, which satisfies needs of use in different scenarios and allows users of varying heights to have a comfortable driving experience; the housing that wraps around the handle assembly and the steering assembly is further included, the locking mechanism is arranged inside the telescopic inner rod assembly, and the locking mechanism is configured to lock the telescopic inner rod assembly and the telescopic outer rod assembly, which prevents extension or retraction of the telescopic inner rod assembly or the telescopic outer rod assembly caused by road vibrations during travel, enhances product stability, and ensures a better user experience; and the pulling mechanism connected to the locking mechanism is arranged inside the housing, the user drives the locking mechanism to move for unlocking by manually toggling the pulling mechanism, and free telescopic adjustment is enabled after unlocking, where the unlocking is simplified for user convenience.

### BRIEF DESCRIPTION OF THE DRAWINGS

FIG. 1 is a perspective view I of the present disclosure.

FIG. 2 is a perspective view II of the present disclosure.

FIG. 3 is a perspective view III of the present disclosure.

FIG. 4 is a perspective view of a locking mechanism and a pulling mechanism of the present disclosure.

FIG. 5 is an exploded view of a locking mechanism of the present disclosure.

FIG. 6 is a schematic diagram I of a locking mechanism of the present disclosure.

FIG. 7 is a schematic diagram II of a locking mechanism of the present disclosure.

FIG. 8 is a sectional view of the present disclosure.

FIG. 9 is a schematic diagram of inside of a housing of the present disclosure.

FIG. 10 is a schematic diagram of a pulling mechanism of the present disclosure.

FIG. 11 is an exploded view I of the present disclosure.

FIG. 12 is an exploded view II of the present disclosure.

FIG. 13 is a schematic diagram of a pulling mechanism of the present disclosure.

### REFERENCE NUMERALS IN THE FIGURES

1-suitcase body assembly; 2-handle assembly; 3-base assembly; 4-front wheel assembly; 5-rear wheel assembly; 6-telescopic outer rod assembly; 7-telescopic inner rod assembly; 8-steering assembly; 9-housing; 10-locking mechanism; 11-pulling mechanism; 12-handle; 13-rotating block; 14-pulling wire; 15-columnar body; 16-base; 17-drive rod; 18-locking block; 19-inserting pin; 20-pin hole; 21-first slot; 22-second slot; 23-reset spring; 24-first inclined block; 25-second inclined block; 26-telescopic outer rod; 27-outer rod sleeve; 28-telescopic inner rod; 29-inner rod sleeve; 30-fork; 31-hub motor; 32-adapter; 33-bearing; 34-handle rod; 35-vertical rod; 36-connector; 37-locator; 38-control panel; 39-brake button; 40-drive ring; 41-display screen; 42-master power switch; 43-charging port; and 44-linkage member.

### DETAILED DESCRIPTIONS OF THE EMBODIMENTS

The technical solutions in the examples of the present disclosure will be clearly and completely described below in combination with the accompanying drawings in the examples of the present disclosure. Apparently, the examples described are merely some rather than all of the examples of the present disclosure. All other examples acquired by those of ordinarily skilled in the art without making creative efforts based on the examples of the present disclosure fall within the scope of protection of the present disclosure.

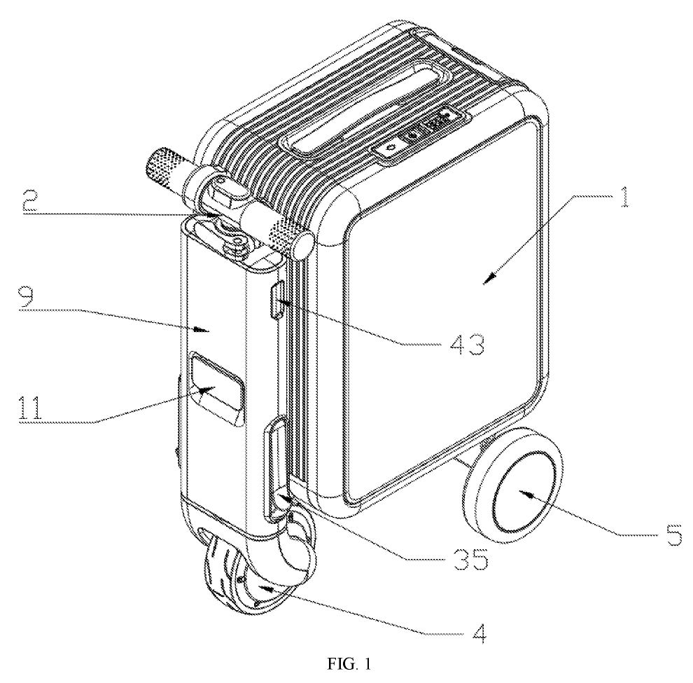

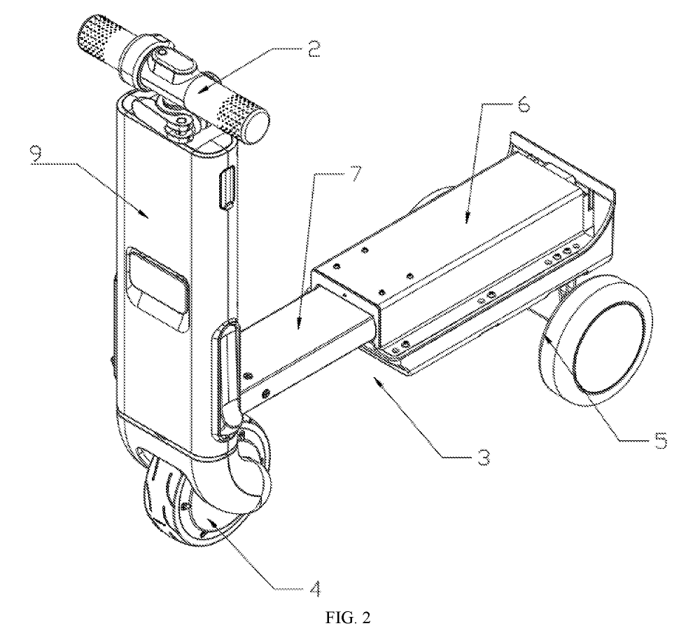

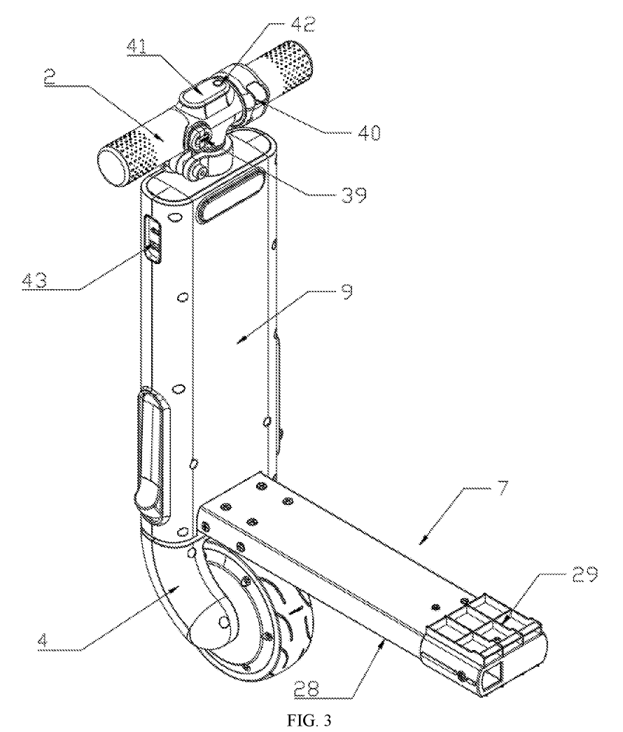

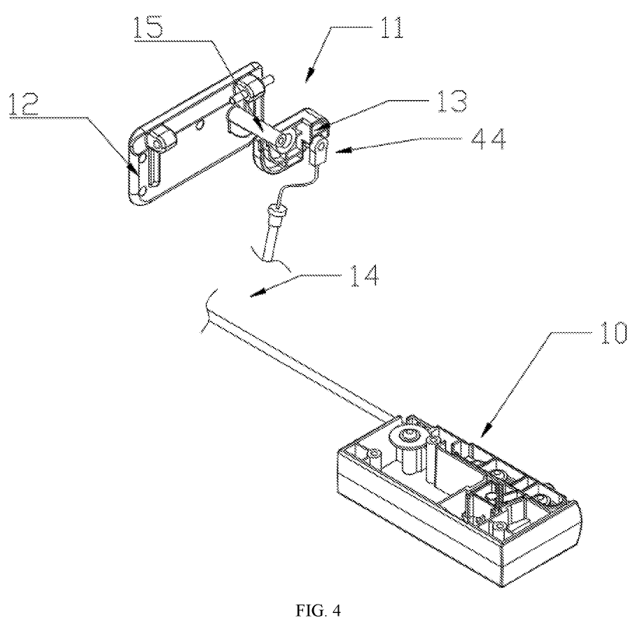

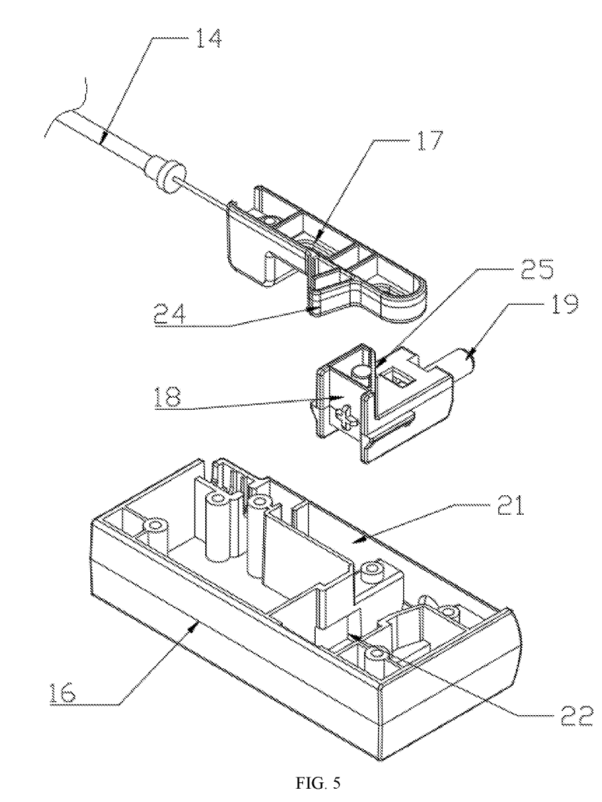

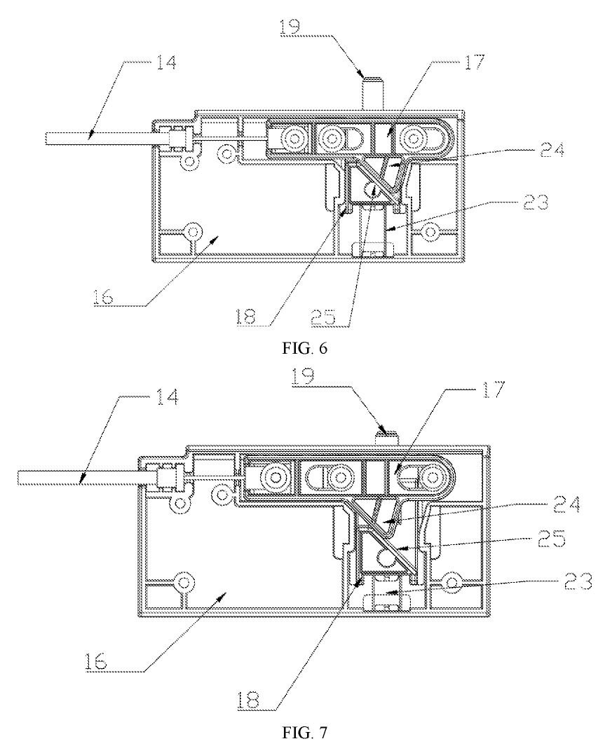

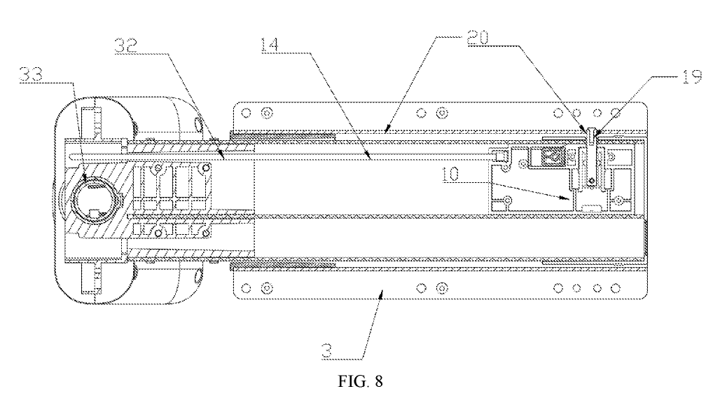

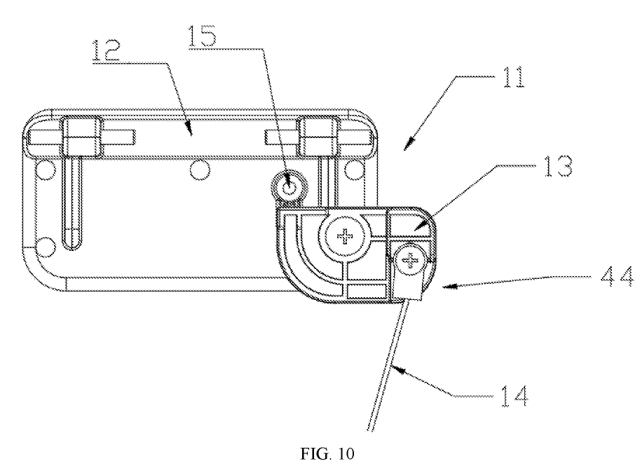

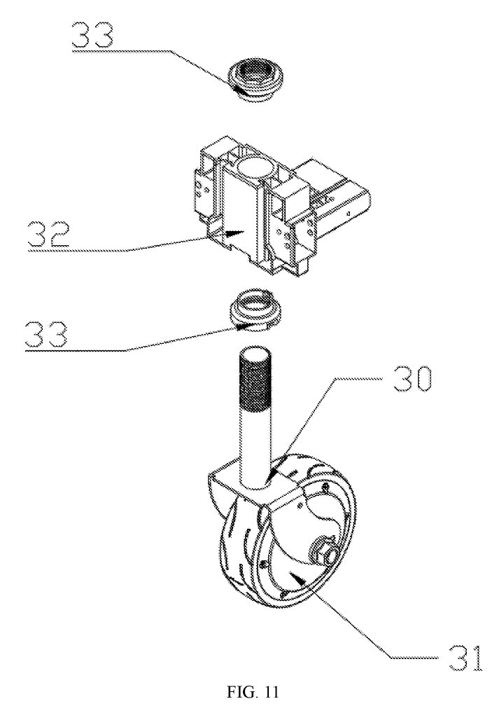

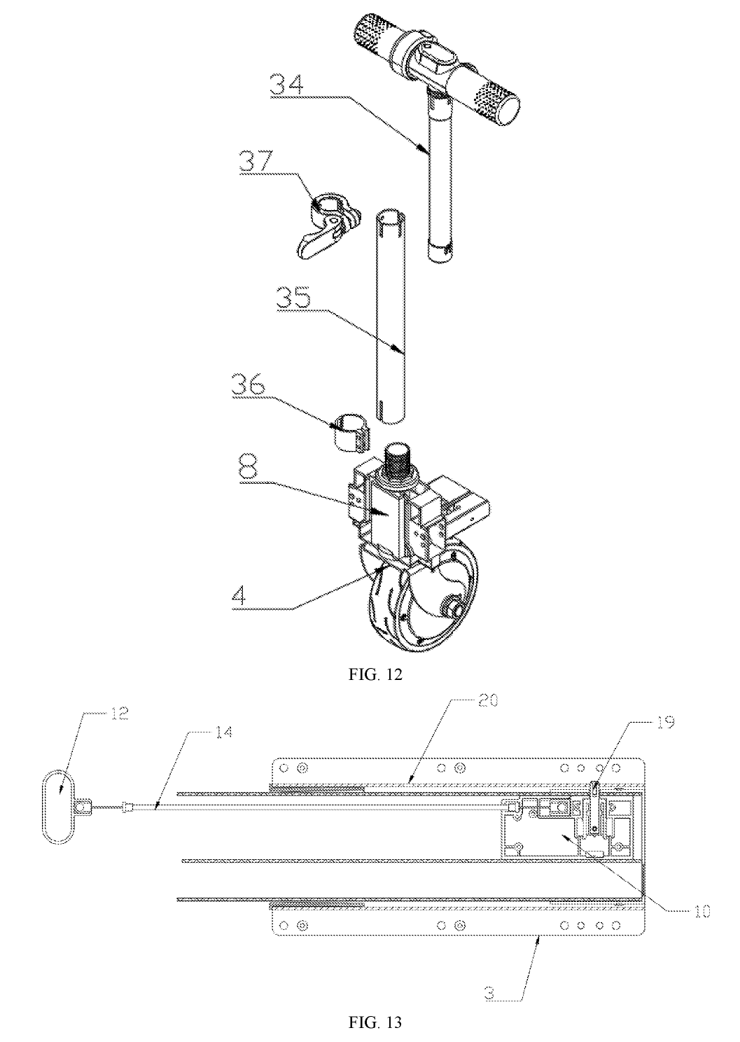

As illustrated in FIGS. 1-13, a telescopic electric suitcase includes a suitcase body assembly 1, a handle assembly 2, a base assembly 3, and a front wheel assembly 4 and a rear wheel assembly 5 arranged at a bottom thereof, where a steering assembly 8 is arranged between the front wheel assembly 4 and the handle assembly 2, the suitcase body assembly 1 is detachably mounted on the base assembly 3, and a user sitting on the suitcase body assembly 1 and holding the handle assembly 2 drives the electric suitcase to move forward. The base assembly 3 includes a telescopic outer rod assembly 6 and a telescopic inner rod assembly 7, one end of the telescopic inner rod assembly 7 is movably connected to inside of the telescopic outer rod assembly 6, the other end thereof is connected to the steering assembly 8, and the user extends or retracts the base assembly 3 according to use needs, which satisfies needs of use in different scenarios and allows users of varying heights to have a comfortable driving experience.

A housing 9 that wraps around the handle assembly 2 and the steering assembly 8 is further included, and the housing 9 is composed of front and rear shells snap-fitted with each other to protect an internal structure. A locking mechanism 10 is arranged inside or outside the base assembly 3, the locking mechanism 10 is configured to lock the telescopic inner rod assembly 7 and the telescopic outer rod assembly 6, which prevents extension or retraction of the telescopic inner rod assembly 7 or the telescopic outer rod assembly 6 caused by road vibrations during travel, enhances product stability, and ensures a better user experience. A pulling mechanism 11 in linked connection with the locking mechanism 10 is further included, the pulling mechanism 11 drives the locking mechanism 10 to move for unlocking, and manual telescopic adjustment is enabled after unlocking, where the unlocking is simplified for user convenience.

The locking mechanism 10 is fixed inside the telescopic inner rod assembly 7 by means of screws, and the locking mechanism 10 includes a base 16, and a drive rod 17 and a locking block 18 movably mounted inside the base 16, where the drive rod 17 is linked to the locking block 18, the pulling mechanism 11 is connected to the drive rod 17, the pulling mechanism 11 pulls the drive rod 17 to move, and the drive rod 17 links the locking block 18 to move to achieve unlocking.

An inserting pin 19 that penetrates through the telescopic inner rod assembly 7 is arranged on a side of the locking block 18, and a plurality of pin holes 20 through which the inserting pin 19 penetrates are formed on the telescopic outer rod assembly 6, where the plurality of pin holes 20 are arranged in a same horizontal direction, and the inserting pin 19 is inserted into the pin hole 20 at a different position to achieve fixing after extension or retraction.

The base 16 is provided with a first slot 21 and a second slot 22 that are communicated with each other, the drive rod 17 is horizontally movably mounted in the first slot 21, the locking block 18 is vertically movably mounted in the second slot 22, a reset spring 23 is arranged between the second slot 22 and the locking block 18, and the locking block 18 is reset through the reset spring 23 after movement, which simultaneously drives the drive rod 17 to reset.

A first inclined block 24 is arranged at a bottom of the drive rod 17, and a second inclined block 25 fitted with the first inclined block 24 is arranged at a top of the locking block 18. When the drive rod 17 moves horizontally, the first inclined block 24 simultaneously moves horizontally, and an inclined surface of the second inclined block 25 gradually moves downward along an inclined surface of the first inclined block 24, such that the locking block 18 drives the inserting pin 19 to disengage from the pin hole 20 downward. In this case, a locking state is released, and the telescopic inner rod assembly 7 is manually extended or retracted. The locking mechanism 10 moves synchronously with the telescopic inner rod assembly 7, and when the inserting pin 19 moves to a position directly below another pin hole 20, the locking block 18 is pushed back by the reset spring 23, and the inserting pin 19 penetrates through the pin hole 20 again to achieve locking.

The pulling mechanism 11 includes a handle 12 and a linkage member 44 that moves with the handle 12, and when the handle 12 is manually operated, the linkage member 44 drives the drive rod 17 to move for unlocking. The linkage member 44 includes a rotating block 13, a pulling wire 14, and a columnar body 15 that protrudes from an inner side of the handle 12, where the rotating block 13 penetrates through a center of the rotating block 13 through a rotating shaft and limited by screws, and the rotating block 13 rotates horizontally with the center as a pivot. The pulling wire 14 is connected to one end of the rotating block 13, the columnar body 15 is in contact with the other end of the rotating block 13, the handle 12 drives the rotating block 13 to rotate through the columnar body 15, which simultaneously drives the pulling wire 14 to move, and the pulling wire 14 drives the drive rod 17 to move, such that the inserting pin 19 is disengaged from the pin hole 20, and a locking state of the locking mechanism 10 is released.

A working principle of the pulling mechanism 11 is as follows: The columnar body 15 is perpendicular to the rotating block 13, when the handle 12 is toggled, the columnar body 15 rotates forward or backward synchronously with the handle 12, and the rotating block 13 rotates horizontally; and when the user pulls the handle 12, the columnar body 15 presses against one side of the rotating block 13, such that the other side of the rotating block 13 connected to the pulling wire 14 ascends, and the pulling wire 14 is pulled.

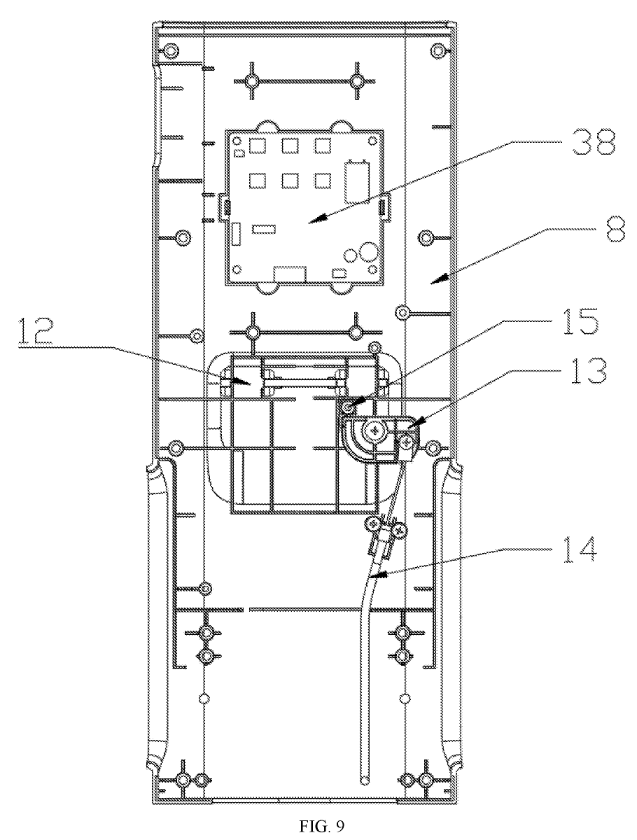

Two embodiments for the above pulling mechanism 11 are as follows: in the first embodiment, as shown in FIGS. 1 and 9, the pulling mechanism 11 is mounted inside the housing 9, and the handle 12 is exposed outside the housing 9; and in the second embodiment, as shown in FIG. 13, the pulling mechanism 11 is mounted inside the base assembly 3, and the handle 12 is exposed on any side of the base assembly 3.

The telescopic outer rod assembly 6 includes a telescopic outer rod 26 and an outer rod sleeve 27 mounted inside the telescopic outer rod 26, and the telescopic inner rod assembly 7 includes a telescopic inner rod 28 and an inner rod sleeve 29 mounted on an outer surface of the telescopic inner rod 28. When the base assembly 3 is fully unfolded, the outer rod sleeve 27 and the inner rod sleeve 29 abut against each other, which prevents further extension thereof and exerts an effect of limiting, and prevents disengagement caused by excessive extension. The outer rod sleeve 27 and the inner rod sleeve 29 are fixed to the telescopic outer rod 26 and the telescopic inner rod 28 at one end thereof by means of screws, respectively.

The front wheel assembly 4 includes a fork 30 and a hub motor 31 mounted below the fork 30, and the steering assembly 8 includes an adapter 32 and bearings 33 for rotation arranged at upper and lower ends of the adapter 32, where the fork 30 sequentially penetrates through the lower bearing 33, the adapter 32 and the upper bearing 33, and is threadedly connected to the handle assembly 2, and the telescopic inner rod assembly 7 is sleeved into a rear portion of the adapter 32 and is fixed by means of screws. The user holding the handle assembly 2 drives the front wheel assembly 4 to rotate for steering, and design of the bearings at upper and lower ends of the adapter 32 enables that the bearings 33 rotate during steering, and the adapter 32 does not rotate, such that the telescopic inner rod assembly 7 does not shift during steering.

The handle assembly 2 includes a handle rod 34, a vertical rod 35, a connector 36, and an adjustable locator 37, where the vertical rod 35 is threadedly connected to an upper end of the fork 30, and the connector 36 is mounted at a threaded joint, to enhance connection between the vertical rod 35 and the fork 30 and prevent disengagement or collapse. The handle rod 34 is telescopically inserted into the vertical rod 35, and the user adjusts a height of the handle rod 34 for optimal driving comfort according to experience. The locator 37 is configured to lock the handle rod 34, the locator 37 is manually toggled to lock or unlock, the handle rod 34 locked cannot be adjusted vertically, and the handle rod 34 unlocked can be adjusted in height, which facilitates intuitive and user-friendly operation.

A charging port 43 is arranged on a side of the housing 9, and a battery is mounted at a bottom of the base assembly 3.

A control panel 38 is arranged inside the housing 9, and the handle rod 34 is provided with a brake button 39, a drive ring 40, and a display screen 41 that are electrically connected to the control panel 38, where a master power switch 42 is arranged on the display screen 41. The brake button 39 is configured for braking of the hub motor 31, the drive ring 40 rotates upward or downward to control a rotational speed of the hub motor 31 for travel speed adjustment, and functions of the display screen 41 include battery level display, reverse gear display, gear position display, speed locking display, and brake display.

Use functions of the control panel 38, the brake button 39, the drive ring 40, the display screen 41, and the master power switch 42 are described as follows: to power on, press and hold the master power switch 42 for 2 sec; to power off, press and hold the master power switch 42 for 3 sec; for gear position switching, press the master power switch 42 twice, where speed options include 3 km/h and 10 km/h; for forward propulsion, rotate the drive ring 40; for reverse propulsion, press the brake button 39 and rotate the drive ring 40, where an initial reversing speed is 2 km/h; and to enable or disable speed locking, simultaneously press and hold the brake button 39 and the master power switch 42 for three sec, where once speed locking is enabled, speed adjustments cannot be achieved by short-pressing the master power switch 42. An underlying logic lies in that when a plugging-in state is detected in an ON or OFF state, all functions are disabled, and “powered off” is a default setting after unplugging a power cord. During charging, indicators of the speed locking display and the battery level display (flashing) are shown on the display screen 41, and when any button is pressed, the speed locking display indicator flashes for 5 sec before turning off. After powering on, the battery level is always displayed on the display screen 41, and the brake display indicator lights up when the brake button 39 is pressed, and lights off after the brake button is released.

A telescopic electric suitcase, includes a suitcase body assembly 1, a handle assembly 2, a telescopic base assembly 3, and a front wheel assembly 4 and a rear wheel assembly 5 arranged at a bottom thereof, where a steering assembly 8 is arranged between the front wheel assembly 4 and the handle assembly 2. The base assembly 3 includes a telescopic outer rod assembly 6 and a telescopic inner rod assembly 7, where one end of the telescopic inner rod assembly 7 is movably connected to inside of the telescopic outer rod assembly 6, and the other end thereof is connected to the steering assembly 8. A locking mechanism 10 configured for locking the base assembly 3 and a pulling mechanism 11 configured for pulling the locking mechanism 10 to movably unlock are further included, where the locking mechanism 10 is fixed inside the telescopic inner rod assembly 7 by means of screws, or alternatively mounted outside the telescopic outer rod assembly 6.

The locking mechanism 10 includes a base 16, a drive rod 17 movably mounted inside the base 16, and a locking block 18 linked to the drive rod 17, where the drive rod 17 is linked to the pulling mechanism 11, and the drive rod 17 drives the locking block 18 to move to achieve unlocking; and an inserting pin 19 for locking the base assembly 3 is arranged on a side of the locking block 18, the pulling mechanism 11 moves to unlock the base assembly 3 through the inserting pin 19, and the telescopic inner rod assembly 7 and the telescopic outer rod assembly 6 are movably adjusted.

When the locking mechanism 10 is mounted inside the telescopic inner rod assembly 7, the inserting pin 19 penetrates through the telescopic inner rod assembly 7, and a plurality of pin holes 20 are formed on the telescopic outer rod assembly 6; and similarly, when the locking mechanism 10 is mounted outside the telescopic outer rod assembly 6, the inserting pin 19 penetrates through the telescopic outer rod assembly 6, and a plurality of pin holes are formed on the telescopic inner rod assembly 7. During unlocking, the locking block 18 drives the inserting pin 19 to movably disengage from the pin hole 20, and the inserting pin 19 is inserted into the pin hole 20 at a different position to achieve fixing after extension or retraction.

For those skilled in the art, it is apparent that the present disclosure is not limited to the details of the above-mentioned exemplary examples, and the present disclosure may be implemented in other specific forms without departing from the spirit or basic features of the present disclosure. Therefore, no matter from which point of view, all the embodiments are to be regarded as exemplary and non-limiting. The scope of the present disclosure is defined by the appended claims rather than the above-mentioned description, and therefore it is intended that all changes which fall within the meaning and scope of equivalency of the claims are embraced in the present disclosure. Any reference symbols in the claims are not to be construed as limiting the claims to which they relate.

What is claimed is:

1. A telescopic electric suitcase, comprising a suitcase body assembly, a handle assembly, a telescopic base assembly, and a front wheel assembly and a rear wheel assembly arranged at a bottom thereof, wherein a steering assembly is arranged between the front wheel assembly and the handle assembly; the base assembly comprises a telescopic outer rod assembly and a telescopic inner rod assembly, wherein one end of the telescopic inner rod assembly is movably connected to inside of the telescopic outer rod assembly, and the other end thereof is connected to the steering assembly;
a locking mechanism is arranged on the base assembly, and the locking mechanism is configured to lock the telescopic inner rod assembly and the telescopic outer rod assembly; and
a pulling mechanism in linked connection with the locking mechanism is further comprised, and the pulling mechanism unlocks the locking mechanism.

2. The telescopic electric suitcase according to claim 1, wherein the locking mechanism comprises a base fixed inside the telescopic inner rod assembly, and a drive rod and a locking block movably mounted inside the base, wherein the drive rod is linked to the locking block, the drive rod is linked to the pulling mechanism, and the drive rod drives the locking block to move to achieve unlocking.

3. The telescopic electric suitcase according to claim 2, wherein an inserting pin for locking the telescopic inner rod assembly and the telescopic outer rod assembly is arranged on a side of the locking block.

4. The telescopic electric suitcase according to claim 3, wherein the base is provided with a first slot and a second slot that are communicated with each other, the drive rod is horizontally movably mounted in the first slot, the locking block is vertically movably mounted in the second slot, and a reset spring is arranged between the second slot and the locking block; and a first inclined block is arranged at a bottom of the drive rod, a second inclined block fitted with the first inclined block is arranged at a top of the locking block, and when the drive rod moves, the first inclined block drives the second inclined block to move.

5. The telescopic electric suitcase according to claim 2, wherein the pulling mechanism comprises a handle and a linkage member that moves with the handle, and the linkage member is connected to the drive rod.

6. The telescopic electric suitcase according to claim 5, wherein the linkage member comprises a rotating block, a pulling wire, and a columnar body that protrudes from an inner side of the handle, wherein the pulling wire is connected to one end of the rotating block, the columnar body is in contact with the other end of the rotating block, and the handle drives the rotating block to rotate through the columnar body, which simultaneously drives the pulling wire to move to release a locking state of the locking mechanism.

7. The telescopic electric suitcase according to claim 1, wherein the telescopic outer rod assembly comprises a telescopic outer rod and an outer rod sleeve mounted inside the telescopic outer rod, and the telescopic inner rod assembly comprises a telescopic inner rod and an inner rod sleeve mounted on an outer surface of the telescopic inner rod.

8. The telescopic electric suitcase according to claim 1, wherein the front wheel assembly comprises a fork and a hub motor mounted below the fork, and the steering assembly comprises an adapter and bearings arranged at upper and lower ends of the adapter, wherein the fork penetrates through the adapter and the two bearings and is connected to the handle assembly, and the telescopic inner rod assembly is connected to the adapter.

9. The telescopic electric suitcase according to claim 8, wherein the handle assembly comprises a handle rod, a vertical rod, a connector, and an adjustable locator, wherein the vertical rod is connected to an upper end of the fork and reinforced through the connector, and the handle rod is telescopically mounted on the vertical rod and fixed through the locator.

10. The telescopic electric suitcase according to claim 1, wherein a housing that wraps around the handle assembly and the steering assembly is further comprised, a control panel is arranged inside the housing, and the handle assembly is provided with a brake button, a drive ring, and a display screen that are electrically connected to the control panel, wherein a master power switch is arranged on the display screen.

11. A telescopic electric suitcase, comprising a suitcase body assembly, a handle assembly, a telescopic base assembly, and a front wheel assembly and a rear wheel assembly arranged at a bottom thereof, wherein a steering assembly is arranged between the front wheel assembly and the handle assembly; the base assembly comprises a telescopic outer rod assembly and a telescopic inner rod assembly, wherein one end of the telescopic inner rod assembly is movably connected to inside of the telescopic outer rod assembly, and the other end thereof is connected to the steering assembly;
a locking mechanism and a pulling mechanism are further comprised, the locking mechanism comprises a base, a drive rod movably mounted inside the base, and a locking block linked to the drive rod, wherein the drive rod is linked to the pulling mechanism, and the drive rod drives the locking block to move to achieve unlocking; and
an inserting pin for locking the base assembly is arranged on a side of the locking block, the pulling mechanism moves to unlock the base assembly through the inserting pin, and the telescopic inner rod assembly and the telescopic outer rod assembly are movably adjusted.

12. The telescopic electric suitcase according to claim 11, wherein the inserting pin penetrates through the telescopic inner rod assembly, a plurality of pin holes are formed on the telescopic outer rod assembly, and the inserting pin is inserted into the pin hole at a different position to achieve fixing after extension or retraction.
